(19) United States
(12) Patent Application Publication
(10) Pub. No.: US 2006/0098770 A1
(43) Pub. Date: May 11, 2006

(54) Synchronizer for passing data from a first system to a second system

(76) Inventors: William F. Harper, Colfax, CA (US); Vicente V. Cavanna, Loomis, CA (US); Roy P. Stone, Gold River, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/984,037

(22) Filed: Nov. 9, 2004

(51) Int. Cl. H04L 7/00

(52) U.S. Cl. 375/356

(57) ABSTRACT

A synchronizer for passing data from a first system that transmits data based on a first clock and a second clock, to a second system that receives data based on a third clock, includes a first set of flip-flops for receiving data from the first system based on the first clock. The synchronizer includes a second set of flip-flops for receiving data from the first system based on the second clock. The synchronizer includes a first multiplexer coupled to outputs of the flip-flops in the first and the second set. The synchronizer includes a controller for controlling the first multiplexer to output data from selected ones of the flip-flops based on the third clock, thereby generating output data to be provided to the second system.

### BACKGROUND

In many data communication applications, there is a need to transfer digital data across a domain boundary. A domain boundary is a border between two systems operating with different clock signals. Data transfers across a boundary are typically accomplished with a synchronizer.

Some existing synchronizers are relatively complex devices that perform full handshaking operations, and that are designed to provide generalized synchronization solutions. These synchronizers are not typically implemented very efficiently (e.g., in terms of gate count).

Thus, there is a need in the art for further improvements in the systems and techniques for effecting data transfers across domain boundaries with minimal errors, and for specific applications, such as the transfer of data between a first system that transmits data with a dual clock and a second system that receives data with a single clock.

### SUMMARY

One form of the present invention provides a synchronizer for passing data from a first system that transmits data based on a first clock and a second clock, to a second system that receives data based on a third clock. The synchronizer includes a first set of flip-flops for receiving data from the first system based on the first clock. The synchronizer includes a second set of flip-flops for receiving data from the first system based on the second clock. The synchronizer includes a first multiplexer coupled to outputs of the flip-flops in the first and the second set. The synchronizer includes a controller for controlling the first multiplexer to output data from selected ones of the flip-flops based on the third clock, thereby generating output data to be provided to the second system.

### BRIEF DESCRIPTION OF THE DRAWINGS

FIG. 1 is a block diagram illustrating a communication system according to one embodiment of the present invention.

FIG. 2 is a schematic diagram illustrating a synchronizer according to one embodiment of the present invention.

FIG. 3 is a state diagram illustrating states of the synchronizer state machine shown in FIG. 2 according to one embodiment of the present invention.

FIG. 4 is a timing diagram illustrating signals of the synchronizer shown in FIG. 2 according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following Detailed Description, therefore, is not to be taken in a limiting sense, and the scope of the present invention is defined by the appended claims.

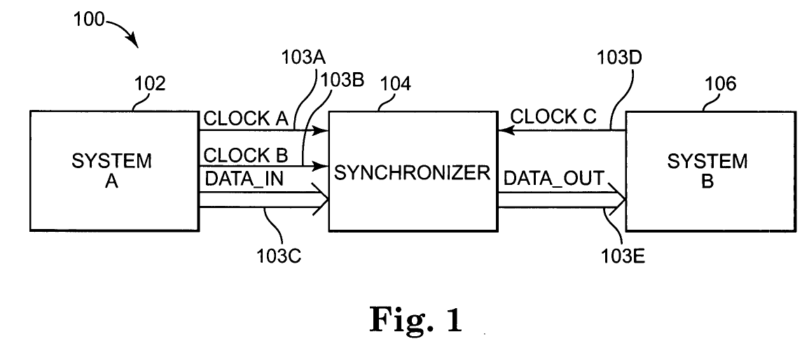

FIG. 1 is a block diagram illustrating a communication system 100 according to one embodiment of the present invention. Communication system 100 includes system A 102, synchronizer 104, and system B 106. In the illustrated embodiment, system A 102 acts as a source or transmitter of data, and system B 106 acts as a receiver or sink of the data transmitted by system A 102. System A 102 is coupled to synchronizer 104 via communication links 103A-103C. System A 102 outputs two clock signals (clock A and clock B) to synchronizer 104 on communication links 103A and 103B. System A outputs digital data signals (data_in) to synchronizer 104 on communication link 103C. System B 106 outputs a clock signal (clock C) to synchronizer 104 on communication link 103D. System B 106 receives digital data signals (data_out) from synchronizer 104 on communication link 103E.

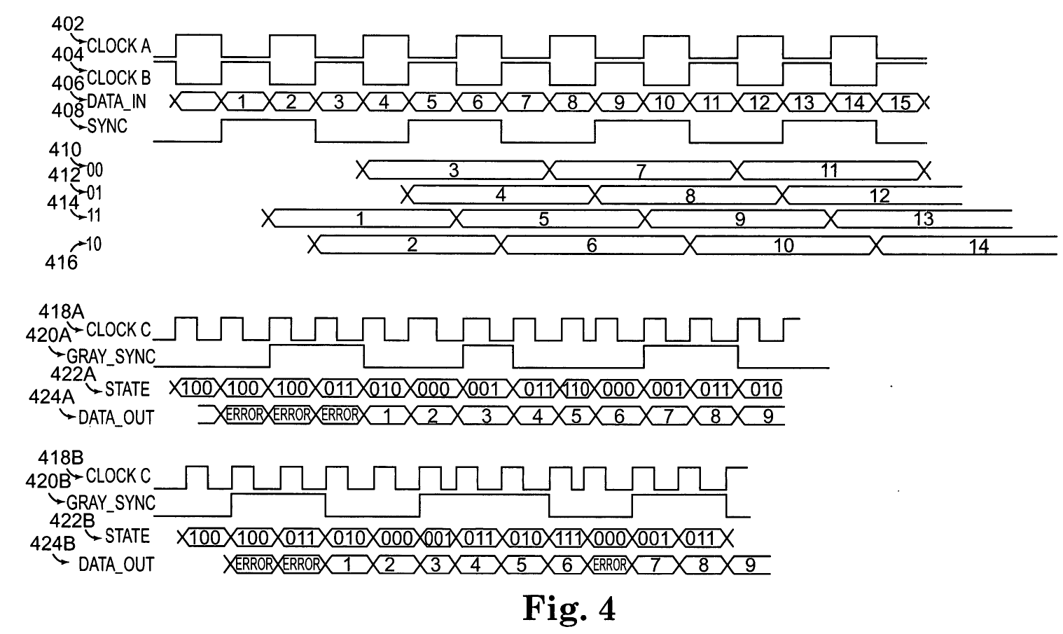

In one embodiment, system A 102 is in a first clock domain and system B 106 is in a second clock domain, which is different than the first clock domain. In one embodiment, the first and the second clock domains are coherent (synchronous) clock domains. In the embodiment shown in FIG. 1, there are dual clocks (clock A and clock B) in the first clock domain, and a single clock (clock C) in the second clock domain. The techniques described herein are also applicable to the case where each of the two clock domains has a single clock. In one embodiment, the clock A and clock B signals output by system A 102 on communication links 103A and 103B have the same frequency, and are 180 degrees out of phase, and the clock C signal output by system B 106 on communication link 103D is at twice the frequency of the clock A and clock B signals. In one form of the invention, the clock A and clock B signals are each 62.5 MHz clock signals, and the clock C signal is a 125 MHz clock signal. In this embodiment, data words are clocked into the synchronizer 104 at 125 MHz using the two separate clocks (clock A and clock B), and the data words are clocked into system B 106 at 125 MHz using a single clock (clock C). In one embodiment, system B 106 derives the clock C signal from the clock A signal or the clock B signal. Embodiments of the clock A, clock B, and clock C signals are shown in FIG. 4, which is described below.

In one form of the invention, communication system 100 uses “8B10B” encoding. With 8B10B encoding, each 8-bit word of data is associated with a 10-bit code-word. In one embodiment, 10-bit code-words are clocked into and out of synchronizer 104 at a rate of 125 MHz. In other embodiments, other communication protocols and speeds may be used.

Synchronizer 104 according to one embodiment is a first-in-first-out (FIFO) based synchronizer that reliably passes data between system A 102 and system B 106. In one form of the invention, the synchronizer 104 transfers data words sourced at one clock rate by system A 102, to system B 106, which removes the data words at another clock rate. In one embodiment, synchronizer 104 is configured to operate in an application that meets the following assumptions: (1) Only the phase relationship between the two clock domains is unknown (i.e., the clocks are assumed to be coherent, and the amount of constant phase difference is unknown); (2) clock jitter is bounded to under one clock period; (3) the flow of data from the transmitter (i.e., system A 102) cannot be throttled.

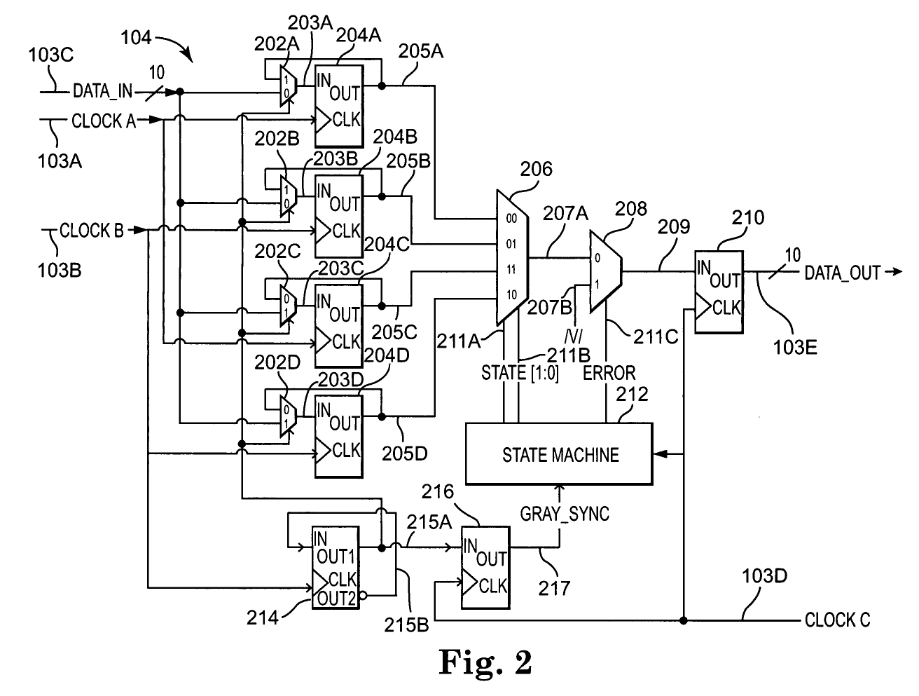

FIG. 2 is a schematic diagram illustrating a synchronizer 104 according to one embodiment of the present invention. Synchronizer 104 includes multiplexers 202A-202D (collectively referred to as multiplexers 202), flip-flops 204A-204D (collectively referred to as flip-flops 204), multiplexers 206 and 208, flip-flop 210, state machine or controller 212, and flip-flops 214 and 216. Flip-flops 204 are also referred to herein as registers 204. Each one of the multiplexers 202 includes two inputs (a “0” input and a “1” input), and one output. Each one of the flip-flops 204, 210, and 216, includes a data input (“in”), a data output (“out”), and a clock input (“clk”). Flip-flop 214 includes a data input (“in”), two data outputs (“out1” and “out2”), and a clock input (“clk”).

The “0” input of multiplexers 202A and 202B, and the “1” input of multiplexers 202C and 202D, are coupled to communication link 103C (data_in). The “1” input of multiplexers 202A and 202B is coupled to the output of flip-flops 204A and 204B, respectively. The “0” input of multiplexers 202C and 202D is coupled to the output of flip-flops 204C and 204D, respectively. The outputs of multiplexers 202A-202D are coupled to the inputs of flip-flops 204A-204D via communication links 203A-203D, respectively. Multiplexers 202 receive control signals or selection signals on communication link 215A, which is coupled to the first output (out1) of flip-flop 214. If the selection signal is low (e.g., a logical zero), multiplexers 202 each output the signal at the “0” input of the multiplexer 202. If the selection signal is high (e.g., a logical one), multiplexers 202 each output the signal at the “1” input of the multiplexer 202.

Communication link 103A (clock A) is coupled to the clock input of flip-flops 204A and 204C. Communication link 103B (clock B) is coupled to the clock input of flip-flops 204B, 204D, and 214. The outputs of flip-flops 204A-204D are coupled to “00”, “01”, “11”, and “10” inputs, respectively, of multiplexer 206 via communication links 205A-205D. Multiplexer 206 receives a two-bit selection signal on communication links 211A and 211B from state machine 212. If both bits of the selection signal are low (i.e., logical zeros), multiplexer 206 outputs the signal at the “00” input of the multiplexer 206. If both bits of the selection signal are high (i.e., logical ones), multiplexer 206 outputs the signal at the “11” input of the multiplexer 206. If the first bit of the selection signal is low, and the second bit is high, multiplexer 206 outputs the signal at the “01” input of the multiplexer 206. If the first bit of the selection signal is high, and the second bit is low, multiplexer 206 outputs the signal at the “10” input of the multiplexer 206.

The output of multiplexer 206 is coupled to the “0” input of multiplexer 208 via communication link 207A. The “1” input of multiplexer 208 is coupled to a “/V/” signal via communication link 207B. The “/V/” signal is an error code in the 8B10B protocol. Multiplexer 208 receives a selection signal on communication link 211C from state machine 212. If the selection signal is low (e.g., a logical zero), multiplexer 208 outputs the signal at the “0” input of the multiplexer 208. If the selection signal is high (e.g., a logical one), multiplexer 208 outputs the signal at the “1” input of the multiplexer 208.

The output of multiplexer 208 is coupled to the data input of flip-flop 210 via communication link 209. Communication link 103D (clock C) is coupled to the clock input of flip-flops 210 and 216, and is also coupled to state machine 212. Flip-flop 210 outputs data (data_out) to system B 106 (FIG. 1) on communication link 103E.

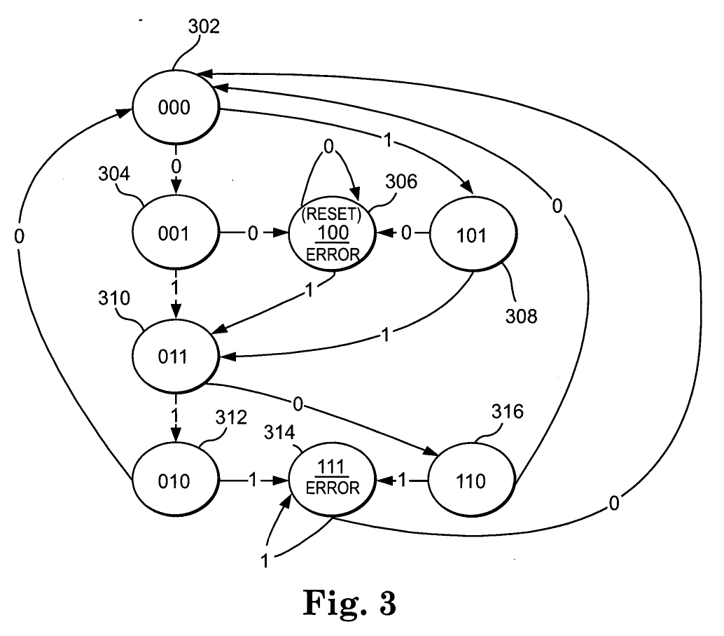

The first output (out1) of flip-flop 214 is coupled to the input of flip-flop 216 via communication link 215A. The second output (out2) of flip-flop 214 is an inverted output that is coupled to the input of flip-flop 214. Flip-flop 214 provides synchronization pulses to flip-flop 216 on communication link 215A. The output of flip-flop 216 is coupled to state machine 212 via communication link 217. Flip-flop 216 provides synchronization pulses to state machine 212 on communication link 217. The signal output by flip-flop 216 to state machine 212 causes the state machine 212 to transition through various states, as described in further detail below with reference to FIG. 3.

As shown in FIG. 2, flip-flops 204A and 204C are clocked by the clock A signal received on communication link 103A, and are, therefore, in the clock A clock domain. Flip-flops 204B, 204D, and 214 are clocked by the clock B signal received on communication link 103B, and are, therefore, in the clock B clock domain. Flip-flop 210, state machine 212, and flip-flop 216 are clocked by the clock C signal received on communication link 103D, and are, therefore, the clock C clock domain. The operation of synchronizer 104 is described in further detail below with reference to FIGS. 3 and 4.

It will be understood by persons of ordinary skill in the art that the logic shown in FIG. 2 will be replicated a number of times based on the number of data bits processed by synchronizer 104 per clock cycle. For example, in an embodiment where synchronizer 104 processes ten bits of data per clock cycle, multiplexers 202A-202D, flip-flops 204A-204D, multiplexers 206 and 208, and flip-flop 210 would each be replicated ten times. In one embodiment, synchronizer 104 includes N multiplexers 202A-202D (4N total), N flip-flops 204A-204D (4N total), N multiplexers 206, N multiplexers 208, and N flip-flops 210, where “N” is an integer representing the number of data bits processed by synchronizer 104 per cycle.

FIG. 3 is a state diagram illustrating states of the synchronizer state machine 212 shown in FIG. 2 according to one embodiment of the present invention. As shown in FIG. 3, state machine 212 includes eight states 302-316. A three-bit value is associated with each of the eight states 302-316. For example, the three-bit value associated with state 302 is “000”. The least significant two bits (right most two bits) of each of the three-bit state values correspond to the signals output by the state machine 212 to multiplexer 206 on communication links 211A and 211B. The transition variable, which is a “1” or a “0”, for determining the transitions between states 302-316, is provided by the output of the flip-flop 216 on communication link 217.

In one embodiment, state machine 212 begins in state 306, which is a reset/error state. The three-bit value corresponding to state 306 is “100”. In state 306, state machine 212 outputs a “1” selection signal to multiplexer 208 on communication link 211C, and a “00” selection signal to multiplexer 206 on communication links 211A and 211B. State machine 212 remains in state 306 as long as the signal output by flip-flop 216 on communication link 217 is low (i.e., a logical zero). When the signal output by flip-flop 216 to state machine 212 goes high (i.e., a logical one), state machine 212 transitions from state 306 to state 310.

The three-bit value corresponding to state 310 is “011”. In state 310, state machine 212 outputs a “0” selection signal to multiplexer 208 on communication link 211C, and a “11” selection signal to multiplexer 206 on communication links 211A and 211B. In state 310, if the signal output by flip-flop 216 to state machine 212 on communication link 217 is a logical one, state machine 212 transitions from state 310 to state 312. In state 310, if the signal output by flip-flop 216 to state machine 212 on communication link 217 is a logical zero, state machine 212 transitions from state 310 to state 316.

The three-bit value corresponding to state 312 is “010”. In state 312, state machine 212 outputs a “0” selection signal to multiplexer 208 on communication link 211C, and a “10” selection signal to multiplexer 206 on communication links 211A and 211B. In state 312, if the signal output by flip-flop 216 to state machine 212 on communication link 217 is a logical one, state machine 212 transitions from state 312 to state 314. In state 312, if the signal output by flip-flop 216 to state machine 212 on communication link 217 is a logical zero, state machine 212 transitions from state 312 to state 302.

The three-bit value corresponding to state 314 is “111”. State 314 is an error state. In state 314, state machine 212 outputs a “1” selection signal to multiplexer 208 on communication link 211C, and a “11” selection signal to multiplexer 206 on communication links 211A and 211B. State machine 212 remains in state 314 as long as the signal output by flip-flop 216 to state machine 212 on communication link 217 is a logical one. In state 314, if the signal output by flip-flop 216 to state machine 212 on communication link 217 transitions to a logical zero, state machine 212 transitions from state 314 to state 302.

The three-bit value corresponding to state 316 is “110”. In state 316, state machine 212 outputs a “0” selection signal to multiplexer 208 on communication link 211C, and a “10” selection signal to multiplexer 206 on communication links 211A and 211B. In state 316, if the signal output by flip-flop 216 to state machine 212 on communication link 217 is a logical one, state machine 212 transitions from state 316 to state 314. In state 316, if the signal output by flip-flop 216 to state machine 212 on communication link 217 is a logical zero, state machine 212 transitions from state 316 to state 302.

The three-bit value corresponding to state 302 is “000”. In state 302, state machine 212 outputs a “0” selection signal to multiplexer 208 on communication link 211C, and a “00” selection signal to multiplexer 206 on communication links 211A and 211B. In state 302, if the signal output by flip-flop 216 to state machine 212 on communication link 217 is a logical one, state machine 212 transitions from state 302 to state 308. In state 302, if the signal output by flip-flop 216 to state machine 212 on communication link 217 is a logical zero, state machine 212 transitions from state 302 to state 304.

The three-bit value corresponding to state 304 is “001”. In state 304, state machine 212 outputs a “0” selection signal to multiplexer 208 on communication link 211C, and a “01” selection signal to multiplexer 206 on communication links 211A and 211B. In state 304, if the signal output by flip-flop 216 to state machine 212 on communication link 217 is a logical one, state machine 212 transitions from state 304 to state 310. In state 304, if the signal output by flip-flop 216 to state machine 212 on communication link 217 is a logical zero, state machine 212 transitions from state 304 to state 306.

The three-bit value corresponding to state 308 is “101”. In state 308, state machine 212 outputs a “0” selection signal to multiplexer 208 on communication link 211C, and a “01” selection signal to multiplexer 206 on communication links 211A and 211B. In state 308, if the signal output by flip-flop 216 to state machine 212 on communication link 217 is a logical one, state machine 212 transitions from state 308 to state 310. In state 308, if the signal output by flip-flop 216 to state machine 212 on communication link 217 is a logical zero, state machine 212 transitions from state 308 to state 306.

FIG. 4 is a timing diagram illustrating signals of the synchronizer 104 shown in FIG. 2 according to one embodiment of the present invention. Clock A signal 402 represents a clock signal output by system A 102 (FIG. 1) to synchronizer 104 on communication link 103A. Clock B signal 404 represents a clock signal output by system A 102 to synchronizer 104 on communication link 103B. Data_in signal 406 represents a data signal output by system A 102 to synchronizer 104 on communication link 103C. In one embodiment, a new data word is clocked into the synchronizer 104 on communication link 103C during each transition of the clock signals 402 and 404. The individual data words are identified in signal 406 by the numbers 1, 2, 3, . . . , 15. In one embodiment, each of the individual data words in signal 406 is a 10-bit value. Sync signal 408 represents a synchronization signal output by flip-flop 214 (FIG. 2) on communication link 215A. As shown in FIG. 4, the sync signal 408 comprises a plurality of pulses, with each pulse having a width of one clock cycle of clock signal 402 or 404, and a spacing between pulses of one clock cycle. In one embodiment, the sync signal 408 output by flip-flop 214 is a gray coded index for indexing the state machine 212, and flip-flop 216 helps to prevent a metastable signal from entering the state machine 212.

Signal 410 shows the data words from the signal 406 that are output by flip-flop 204A (FIG. 2) on communication link 205A to the “00” input of multiplexer 206. As shown in FIG. 4, flip-flop 204A outputs the data words corresponding to numbers 3, 7, and 11 in signal 406. Signal 412 shows the data words from the signal 406 that are output by flip-flop 204B (FIG. 2) on communication link 205B to the “01” input of multiplexer 206. As shown in FIG. 4, flip-flop 204B outputs the data words corresponding to numbers 4, 8, and 12 in signal 406. Signal 414 shows the data words from the signal 406 that are output by flip-flop 204C (FIG. 2) on communication link 205C to the “11” input of multiplexer 206. As shown in FIG. 4, flip-flop 204C outputs the data words corresponding to numbers 1, 5, 9, and 13 in signal 406. Signal 416 shows the data words from the signal 406 that are output by flip-flop 204D (FIG. 2) on communication link 205D to the “10” input of multiplexer 206. As shown in FIG. 4, flip-flop 204D outputs the data words corresponding to numbers 2, 6, 10, and 14 in signal 406.

As shown by signals 410-416 in FIG. 4, each of the data words from the data_in signal 406 is sampled and then held at the output of one of the flip-flops 204A-204D for a period of two clock cycles of clock signal 402 or 404. Thus, each of the data words essentially has a two clock cycle window. However, the two clock cycle windows are divided at a clock boundary, so in one embodiment, the synchronizer 104 is configured to handle up to one full clock cycle of jitter.

The operation of synchronizer 104 is affected by the clock C signal output by system B 106 (FIG. 1) to synchronizer 104 on communication link 103D, and the relation of the clock C signal to clock signals 402 and 404. Signals 418A-424A illustrate a first example of the operation of synchronizer 104, with a clock C signal that begins in synchronization with clock signals 402 and 404, drifts right, and then drifts left. Signals 418B-424B illustrate a second example of the operation of synchronizer 104, with a clock C signal that lags behind clock signals 402 and 404, drifts left, and then drifts right.

Clock C signal 418A represents a clock signal output by system B 106 (FIG. 1) to synchronizer 104 on communication link 103D. As shown in FIG. 4, clock C signal 418A begins in synchronization with clock signals 402 and 404, drifts right, and then drifts left. Gray_sync signal 420A represents the synchronization signal output by flip-flop 216 to state machine 212 on communication link 217. As shown in FIG. 4, the signal 420A comprises a plurality of pulses of varying widths, and with varying spacing between pulses. The varying width and spacing of the pulses is caused by the drift of the clock C signal 418A. State signal 422A shows the states over time of state machine 212, with each of the states identified by the three-bit value corresponding to the state. Data_out signal 424A represents the data signal output by synchronizer 104 to system B 106 on communication link 103E. As shown in FIG. 4, the data_out signal 424A includes the same data words as the data_in signal 406. As can be seen by comparing data_out signal 424A with signals 410-416, each of the individual data words in the data_out signal 424A falls within the corresponding two clock cycle window for that data word shown by signals 410-416.

As shown by signal 422A, state machine 212 begins in state “100”, which is a reset state, remains in this state for a few clock cycles, and then transitions to state “011”. In state “100”, state machine 212 causes multiplexer 208 (FIG. 2) to output the value at the “1” input of the multiplexer 208, which is an error code. The error code is output from multiplexer 208 to flip-flop 210, which outputs the error code on communication link 103E during the next low-to-high transition of the clock signal 418A.

In state “011”, state machine 212 causes multiplexer 208 to output the value at the “0” input of the multiplexer 208, which is coupled to the output of multiplexer 206. The least two significant bits of the state “011” are “11”. Thus, state machine 212 causes multiplexer 206 to output the value at the “11” input of the multiplexer 206, which is coupled to the output of flip-flop 204C. As shown by signal 414, the value held at the output of flip-flop 204C during state “011” is the data word number 1. Multiplexer 206 outputs the data word number 1 through multiplexer 208 to the input of flip-flop 210, which outputs the data word number 1 on communication link 103E during the next low-to-high transition of the clock signal 418A.

After state “011”, state machine 212 transitions to the other states shown in signal 422A: “010”, “000”, “001”, . . . , “010”. The least two significant bits of the three-bit state values correspond to one of the flip-flops 204A-204D. As shown by signal 422A, the least significant two bits of the states are in a pattern, 11, 10, 00, 01, which is continually repeated. Thus, after causing multiplexer 206 to select the output from flip-flop 204C in state “011”, state machine 212 then causes multiplexer 206 to select, in turn, the outputs from flip-flop 204D, flip-flop 204A, and then flip-flop 204B. State machine 212 then returns to flip-flop 204C, and the process is repeated. Each time one of the flip-flops 204A-204D is selected by multiplexer 206, the data word held at the output of the selected flip-flop 204 is output through multiplexers 206 and 208 to the input of flip-flop 210, which outputs the data word on communication link 103E during the next low-to-high transition of the clock signal 418A.

Signals 418B-424B illustrate a second example of the operation of synchronizer 104. Clock C signal 418B represents a clock signal output by system B 106 (FIG. 1) to synchronizer 104 on communication link 103D. As shown in FIG. 4, clock C signal 418B lags behind clock signals 402 and 404, drifts left, and then drifts right. Gray_sync signal 420B represents the synchronization signal output by flip-flop 216 to state machine 212 on communication link 217. As shown in FIG. 4, the signal 420B comprises a plurality of pulses of varying widths, and with varying spacing between pulses. The varying width and spacing of the pulses is caused by the drift of the clock C signal 418B. State signal 422B shows the states over time of state machine 212, with each of the states identified by the three-bit value corresponding to the state. Data_out signal 424B represents the data signal output by synchronizer 104 to system B 106 on communication link 103E. As shown in FIG. 4, the data_out signal 424B includes the same data words as the data_in signal 406, but also includes an error code inserted between the data words identified by numbers 6 and 7, which is caused by the drift of clock 418B. As can be seen by comparing data_out signal 424B with signals 410-416, each of the individual data words in the data_out signal 424B falls within the corresponding two clock cycle window for that data word shown by signals 410-416.

For signals 418B-424B, state machine 212 causes multiplexer 206 to select, in turn, the outputs from flip-flop 204C, flip-flop 204D, flip-flop 204A, and then flip-flop 204B, in a repeating pattern, in the same manner as described above with respect to signals 418A-424A. However, as shown by signal 422B, during the time that data word number 6 (from flip-flop 204D) is being output by flip-flop 210, state machine 212 is in state “111”, which is an error state. In state “111”, state machine 212 causes multiplexer 208 to output the value at the “1” input of the multiplexer 208, which is an error code. The error code is output from multiplexer 208 to flip-flop 210, which outputs the error code on communication link 103E during the next low-to-high transition of the clock signal 418B. As shown by signal 422B, the next state after state “111” is state “000”, which corresponds to flip-flop 204A. Thus, after the error code is inserted into the data stream, data word number 7 from flip-flop 204A is output by flip-flop 210 on communication link 103E, and state machine 212 continues to select the flip-flops 204A-204D in the repeating pattern.

One form of the present invention provides a synchronizer 104 that is more efficient (e.g., in terms of gate count) than prior synchronizers, and has a minimum amount of latency. The synchronizer 104 according to one embodiment resists high frequency jitter in the clocks up to a magnitude of one clock period. In one form of the invention, the synchronizer 104 includes error detection capabilities to help guarantee the reliability of the data transferred by the synchronizer. In one embodiment, the synchronizer 104 incorporates built-in recovery from a FIFO overflow or underflow state that may have resulted from a violation of the assumptions (described above with respect to FIG. 1) under which the synchronizer 104 will operate correctly. In one embodiment, synchronizer 104 is configured to be used in Ethernet applications, memory applications, as well as other applications. The synchronizer 104 according to one form of the invention has many applications in input/output (I/O) front ends, where the clock is typically provided by the source of the data (source-synchronous), and the receiver has a version of the clock that is derived from the source's clock, but has undergone a phase shift of unknown magnitude. This includes such diverse industry standards as PCIx 2.0 (DDR PClx), Fiber Channel, and Gigabit Ethernet.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A synchronizer for passing data from a first system that transmits data based on a first clock and a second clock, to a second system that receives data based on a third clock, the data synchronizer comprising:
a first set of flip-flops for receiving data from the first system based on the first clock;
a second set of flip-flops for receiving data from the first system based on the second clock;
a first multiplexer coupled to outputs of the flip-flops in the first and the second set; and
a controller for controlling the first multiplexer to output data from selected ones of the flip-flops based on the third clock, thereby generating output data to be provided to the second system.

2. The synchronizer of claim 1, wherein the first set of flip-flops includes 2N flip-flops that are configured to be clocked by the first clock, and the second set of flip-flops includes 2N flip-flops that are configured to be clocked by the second clock, where N is an integer representing a number of data bits processed by the synchronizer per cycle.

3. The synchronizer of claim 1, wherein the synchronizer includes a data input for receiving data from the first system, and wherein the synchronizer further comprises a first plurality of multiplexers, each multiplexer in the first plurality having a first input connected to the data input and an output connected to an input of one of the flip-flops.

4. The synchronizer of claim 3, wherein each multiplexer in the first plurality includes a second input connected to an output of one of the flip-flops.

5. The synchronizer of claim 4, and further comprising a first control signal generator for generating a first set of control signals based on the second clock signal that control the first plurality of multiplexers.

6. The synchronizer of claim 5, and further comprising a second control signal generator for generating a second set of control signals based on the first set of control signals and the third clock signal.

7. The synchronizer of claim 6, wherein the controller is configured to control the first multiplexer to output data from selected ones of the flip-flops based on the third clock and the second set of control signals.

8. The synchronizer of claim 1, wherein the controller is configured to identify if an error has occurred during the passing of data from the first system to the second system.

9. The synchronizer of claim 8, wherein the controller is configured to cause an error code to be inserted into the data passed to the second system when the controller identifies that an error has occurred.

10. The synchronizer of claim 9, and further comprising a second multiplexer having a first input coupled to an output of the first multiplexer, and a second input coupled to an error code provider, and wherein the controller is configured to cause the second multiplexer to insert the error code into the data passed to the second system when the controller identifies that an error has occurred.

11. The synchronizer of claim 1, and further comprising an output flip-flop for receiving data from the first multiplexer, the output flip-flop configured to output the received data to the second system based on the third clock.

12. The synchronizer of claim 1, wherein the data transmitted from the first system is clocked into the synchronizer in 10-bit words based on the first clock and the second clock, and wherein data output from the synchronizer to the second system is clocked out of the synchronizer in 10-bit words based on the third clock.

13. The synchronizer of claim 1, wherein the first clock and the second clock operate at a first frequency, and wherein the third clock operates at twice the first frequency.

14. The synchronizer of claim 13, wherein the first clock and the second clock are 180 degrees out of phase, and wherein the third clock is derived from at least one of the first clock and the second clock.

15. The synchronizer of claim 1, wherein the controller is implemented with a state machine.

16. A method of transferring data from a first system that transmits data based on a first clock and a second clock to a second system that receives data based on a third clock, the method comprising:
clocking data from the first system into a first plurality of flip-flops based on the first clock and into a second plurality of flip-flops based on the second clock;
outputting data from the flip-flops in the first and the second plurality to a first multiplexer; and
controlling the first multiplexer to output data from selected ones of the flip-flops based on the third clock, thereby generating output data to be provided to the second system.

17. The method of claim 16, wherein the first clock and the second clock operate at a first frequency, and wherein the third clock operates at twice the first frequency.

18. A synchronized communication system, the system comprising:
a transmitter for transmitting a first stream of data words based on a first and a second clock signal;
a synchronizer comprising:
a first set of flip-flops for receiving a first subset of the data words from the transmitter based on the first clock signal;
a second set of flip-flops for receiving a second subset of the data words from the transmitter based on the second clock signal;
a first multiplexer coupled to outputs of the flip-flops in the first and the second set; and
a controller for controlling the first multiplexer to output data words from selected ones of the flip-flops based on a third clock signal, thereby generating a second stream of data words; and
a receiver for receiving the second stream of data words.

19. The synchronized communication system of claim 18, wherein the first clock signal and the second clock signal are at a first frequency, and wherein the third clock signal is at twice the first frequency.

20. The synchronized communication system of claim 18, wherein the first clock signal and the second clock signal are 180 degrees out of phase, and wherein the third clock signal is derived from at least one of the first clock signal and the second clock signal.
